(19) United States
(12) Patent Application Publication
(10) Pub. No.: US 2008/0201089 A1
(43) Pub. Date: Aug. 21, 2008

(54) SYSTEM AND METHOD FOR DETERMINING NEUTRAL TEMPERATURE OF A METAL

(75) Inventors: Christian Diaz, Falls Church, VA (US); Gary A. Carr, Falls Church, VA (US)

Correspondence Address: NIXON PEABODY, LLP, 401 9TH STREET, NW, SUITE 900, WASHINGTON, DC, 20004-2128, US

(73) Assignee: ENSCO, INC., Falls Church, VA (US)

(21) Appl. No.: 11/972,852

(22) Filed: Jan. 11, 2008

Related U.S. Application Data
(60) Provisional application No. 60/879,813, filed on Jan. 11, 2007.

(51) Int. Cl. G01N 19/00; G01K 11/30; G01P 15/00

(52) U.S. Cl. 702/56; 702/135; 702/141

(57) ABSTRACT

A system for determining a neutral temperature of a metal specimen includes an excitation assembly disposed adjacent to the metal specimen for inducing vibrations to the metal specimen, at least one vibration detector disposed adjacent to the metal specimen to measure the induced vibrations transmitted in the metal specimen, a temperature sensor disposed adjacent to the metal specimen to measure temperature of the metal specimen, and a control/acquisition system for control of the excitation assembly and acquisition of data from the excitation assembly, the at least one vibration detector, and the temperature sensor, wherein the control/acquisition system calculates damping coefficients for each of the induced vibrations and determines a peak damping coefficient corresponding to the neutral temperature of the metal specimen based upon the acquired data.

### BACKGROUND OF THE INVENTION

1. Field of the Invention

The present invention is directed to a system and method for determining neutral temperature of a metal.

2. Description of Related Art

A problem currently affecting railroads is the buckling of rail due to excessive compressive stresses caused by thermal expansion in high temperature conditions. One method of addressing this problem is to examine the neutral temperature of the metal of the rail. The neutral temperature of a metal is the temperature at which its net tensile and compressive stresses in the metal, due to thermal contraction or expansion, are zero. This neutral temperature changes over time due to use, fracture, maintenance, corrosion, load changes, and climate changes. However, the neutral temperature can be adjusted by inducing stresses in the metal when needed.

For a continuously welded steel rail, the neutral temperature is extremely important. In particular, changes in the neutral temperature of 1° C. can result in forces of up to 17.5 kN in the rail. Such compressive and tensile stresses resulting from forces caused by changes in the neutral temperature can result in rail buckling or cracking, which can lead to rail car derailment. Correspondingly, accurate measurement and monitoring of the neutral temperature is very important.

Currently, all widely accepted methods of measuring the neutral temperature of a metal are inaccurate or destructive to the metal and very labor intensive. Therefore, there exists an unfulfilled need for a practical system and method that will accurately measure the neutral temperature of a metal, such as in rails used by railroads. In addition, there also exists an unfulfilled need for such a system and method that measures the neutral temperature without damaging the metal being measured. Furthermore, there is also an unfulfilled need for such a system and method that is easy to implement and use.

### SUMMARY OF THE INVENTION

In view of the foregoing, an advantage of the present invention is in providing a system and method that allows accurate measurement of the neutral temperature of a metal such as a steel rail.

Another advantage of the present invention is in providing such a system and method that measures the neutral temperature without damaging the metal.

Still another advantage of the present invention is in providing such a system and method that is easy to implement and use.

Still another advantage of the present invention is in providing a method that determines maximum damping of a metal due to thermal stresses.

It has been suggested that the neutral temperature can be determined by measuring the internal damping of a metal specimen, such as a rail or pipe. The internal damping of the metal should be at a maximum when the metal is absent of any tensile or compressive forces, i.e., net tensile or compressive forces is approximately zero. This effect is called the Snoek Effect, and is caused by interactions at the atomic and molecular levels. Thus, this effect cannot be explained or modeled by simply looking at classic mechanics of deformable solids.

The Snoek Effect is caused by the behavior of interstitial carbon or nitrogen atoms in body-centered-cubic (BCC) metals such as steel. The interstitial carbon or nitrogen atoms are much smaller than the iron atoms, and can therefore, occupy the small vacant spaces at the center of the edges of the cube-structured crystal. When a tensile force is applied to an otherwise unstressed metal, tensile stress results and the cubic structure is elongated in the direction of the force, while planes normal to the direction of the force undergo Poisson compression. This causes the interstitial atoms that lie along these normal planes to shift into the now larger vacant positions along planes parallel with the stress.

FIG. 1 demonstrates this effect, and illustrates the movement of interstitial atoms due to stress. In particular, FIG. 1 is a schematic illustration of BCC structure 1 of steel including interstitial carbon atom “C”. While the metal is under high tensile or compressive forces, the crystalline BCC structure is already highly deformed. Smaller applied stresses in any direction does not significantly alter the direction of deformation of the BCC structure. Therefore, the interstitial carbon atoms are unable to move and the Snoek Effect is not observed. However, when approximately little to no net tensile or compressive force is present in the metal, the applied forces have a large impact on the deformation of the structure, allowing the interstitial atoms to move easily, so as to readily exhibit the Snoek Effect. In accordance with the Snoek Effect, this causes the interstitial atoms to oscillate between vacancy positions as the shape of the BCC structure changes. In particular, in the illustration of FIG. 1, the interstitial carbon C moves to the plane of the BBC that is parallel to the direction of stress σ.

In view of the above, the system and method of the present invention induces vibration in the metal, and the resulting vibration is measured to determine the temperature at which the maximum damping occurs. This temperature at which the maximum damping occurs is the neutral temperature of the metal. When the metal is subject to a vibration at zero net stress, the BCC structure will rapidly oscillate between a deformed state and a neutral state. In accordance with the present invention, in order to observe/capture substantially low frequency responses, i.e., below about 1 kHz, of the metal, a mechanical-based induced vibration system using a relatively medium-sized impact hammer, for example, may be implemented to induce vibrations in the metal. Accordingly, an accelerometer or accelerometers attached to the metal may be used to detect and record the induced vibrations. Locations of the accelerometer(s) is based to maximize the number of vibration modes to be accurately measured.

In order to observe/capture substantially medium frequency responses, i.e., between about 1 kHz and about 20 kHz, of the metal, a mechanical-based induced vibration system using a relatively small-sized impact hammer, for example, may be implemented to induce vibrations in the metal. Accordingly, an accelerometer or accelerometers attached to the metal may be used to detect and record the induced vibrations. As with the substantially low frequency responses, locations of the accelerometer(s) is based to maximize the number of vibration modes to be accurately measured.

In order to observe/capture substantially high frequency responses, i.e., greater than about 20 kHz, of the metal, a laser-based induced vibration system using laser pulses may be used to generate induced vibrations in the metal. In order to observe the substantially high frequency responses, acoustical transducers, i.e., ultrasonic transducers spaced apart from the metal may be used to detect and record the induced vibrations. Moreover, a laser-based induced vibration system may propagate a wave at various frequencies along the metal with no contact to the metal, as opposed to the mechanical-based induced vibration systems. Such a laser system is utilized to generate laser beam pulses at a desired frequency, which contacts the surface of the metal to produce vibrations therein. Thus, a laser induced vibration system is very suited for preserving the structural shape and integrity of the metal, which would otherwise be effected by standard vibration inducing methods.

When the beam of the laser comes into contact with the metal, contaminant particles, including debris, water, corrosion, or any other foreign particles present vaporize, and are expelled away from the metal at the particular contact location. The motion of the particles leaving the surface of the metal creates an equal and opposite reaction force on the metal. This small, but almost instantaneous force is enough to induce a vibration through the metal that can then be detected. Thus, the laser's effect is to produce a “white noise” vibration, with a very broad range of frequencies.

The vibration of the metal is then measured using ultrasonic transducers in accordance with one embodiment of the present invention. In accordance with one implementation, the transducers are placed on the opposite side of the metal, such as the rail, with the laser acting on the rail top surface. In other embodiments, the transducers may be positioned adjacent the rail, directly opposite the laser. In this way, the response detected are the vibrations that travel through the center of the rail, such vibrations most accurately describing the characteristics of the rail. In addition, placing the transducer in such a manner is also likely to provide the highest signal strength.

In implementation, the choice of frequency is important since for very low frequencies, the interstitial atoms can move freely, while at very high frequencies, they do not have enough time to react. In both cases, the stress and strain in the material are in phase with each other. However, at intermediate frequencies corresponding to the time required for a jump to occur, the strain response is not as fast as the applied stress, and a phase lag between stress and strain develops. This phase lag causes a large rise in energy dissipation, i.e. internal damping of the metal. The peak in the damping force is called the Snoek Peak and the temperature at which this peak occurs corresponds to the neutral temperature of the metal.

In some cases, multiple Snoek Peaks may be seen for a metal. This is due to the metal having different interstitial atoms present with differing diffusion rates at different frequencies. However, the effects of tensile and compressive stresses are the same for all Snoek Peaks, and having multiple peaks do not significantly skew the results obtained. These peaks indicate the substantially the same neutral temperature with negligible differences. In a steel rail, the peak representing the diffusion of the carbon atoms is greater than that of the other interstitial atoms due to much higher concentration of carbon.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic illustration showing the movement of interstitial atoms due to stress resulting in the Snoek Effect.

FIG. 2 is a schematic illustration of a system in accordance with one example implementation of the present invention.

FIG. 3 is a schematic illustration of a system in accordance with another example implementation of the present invention.

FIG. 4 is a schematic illustration of the damping coefficient versus temperature curve as measured using system and method in accordance with one embodiment of the present invention.

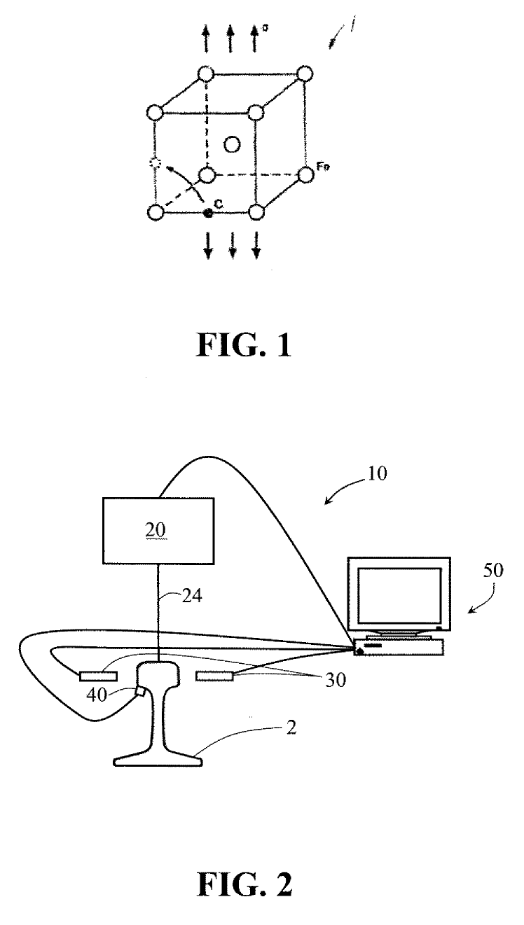

### DETAILED DESCRIPTION OF THE PREFERRED EMBODIMENTS

FIG. 2 is a schematic illustration of a system 10 for determining the neutral temperature of a metal in accordance with one example implementation of the present invention. It should be noted that whereas the system 10 is described herein as being used to determine the neutral temperature of a rail 2, the present invention is not limited thereto, and may be used to determine the neutral temperature of other metals and metal objects in other applications.

As can be seen in FIG. 2, the system 10 includes an excitation assembly 20, such as a laser assembly, that is positioned above the metal for which the neutral temperature is to be determined, such as the rail 2. The system 10 also includes vibration detectors 30, i.e., ultrasonic acoustic transducers, that are positioned along the sides of the rail 2 in close proximity to the rail 2. Although a pairs of vibration detectors 30 are shown, at least one vibration detector 30 may be used. The system 10 further includes a temperature sensor 40, which in the illustrated implementation, is placed on the rail in close proximity to the area of the rail 2 contacted by the laser pulse generated by the laser assembly 20. The temperature sensor 40 may be a thermal couple that is attached to the rail 2, or other temperature measuring device such as non-contacting infrared temperature sensors, for example. The laser assembly 20, the ultrasonic transducers 30, and the temperature sensor 40 are electrically connected to a control/acquisition system 50, i.e., a data processing computer, of the system 10 for control of the excitation assembly 20 and acquisition of data from the excitation assembly 20, the vibration detector 30, and the temperature sensor 40.

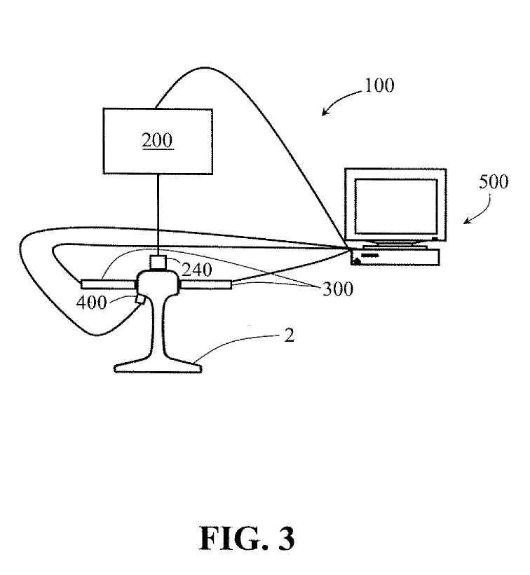

Alternatively, as shown in FIG. 3, the laser assembly 20 may be replaced with a mechanical assembly 200 to provide a mechanical-based induced vibration system 100. For example, the mechanical assembly 200 may include an impact hammer 240 having the ability to impact the rail 2 with varying amounts of measurable energy. Accordingly, an accelerometer or accelerometers 300 attached to the rail 2 may be used to detect and record the induced vibrations, and temperature sensor 400 can detect the temperature of the rail 2 during the detection and recording of the induced vibrations. For substantially low frequency responses, locations of the accelerometer(s) 300 is based to maximize the number of vibration modes to be accurately measured. The mechanical assembly 200 may also be used depending on the configuration of the rail 2 and/or other types of metal specimens for measurement other than the rail 2. Here, the data processing computer 500 is used to record data output from the mechanical assembly 200, the accelerometer(s) 300, and the temperature sensor 400 to analyze the recorded data across a range of frequencies to determine the neutral temperature of the rail 2, as detailed below.

In FIG. 2, the laser assembly 20 is operated by the data processing computer 50 to generate laser pulses 24 approximately every thirty seconds to a surface if the rail 2, thereby inducing a vibration in the rail 2. The operation of the laser assembly 20 is controlled and recorded by the data processing computer 50. The vibration is measured by the ultrasonic transducers 30 and a corresponding signal from the ultrasonic transducers 30 is recorded by the data processing computer 50 for analysis. In addition, the temperature of the rail 2 is measured by the temperature sensor 40, and the signal from the temperature sensor 40 is recorded by the data processing computer 50 for every laser pulse 24 for analysis. The signal strength is also monitored for the duration of the operation of the system 10 so that if the signal strength drops significantly due to the cleansing effect of the laser pulse 24, the position of the sensors and the laser pulse can be moved to a new location on the rail 2.

For analysis of the substantially low frequency responses described above using the data processing computer 500 (in FIG. 3), upon completion of acquiring vibration and temperature data, the recorded data are analyzed across a range of frequencies The accelerometer data collected is then processed using a Fast Fourier Transform (FFT) in order to determine the rail's resonant frequencies. For each of the peaks in the resulting FFT, the corresponding damping ratio, denoted as ξ, is calculated by using the 3 dB down method. The 3 db down method includes determining the damping ratio, which is expressed as:

$$ξ = \frac{{ω}_{B} - {ω}_{A}}{2 {ω}_{D}}$$

where ω_{D} is the frequency associated with the peak and ω_{B} and ω_{A} are defined as:

$$H \vert {ω}_{A} \vert = H \vert {ω}_{B} \vert = \frac{H \vert {ω}_{D} \vert}{\sqrt{2}}$$

where represents the Power Spectral Density (PSD) magnitudes corresponding to those frequencies.

For analysis of the substantially medium and high frequency responses described above, upon completion of acquiring vibration and temperature data, the recorded data are analyzed across a range of frequencies. Such analysis is performed using the data processing computer 50 of the system 10. In particular, the displacement of the rail 2 as measured by the ultrasonic transducers 30 is plotted versus time for each laser pulse. By fitting a logarithmic best-fit curve to the peaks of the resulting plot, the damping ratio can be found using the equation:

x(t)=Ae^{-ξωt} sin (ω_{d}t+Φ) Eq. (1)

where ξ is the damping ratio, ω_{d} is the damped natural frequency, A is the amplitude of the signal, and Φ is the phase shift of the signal.

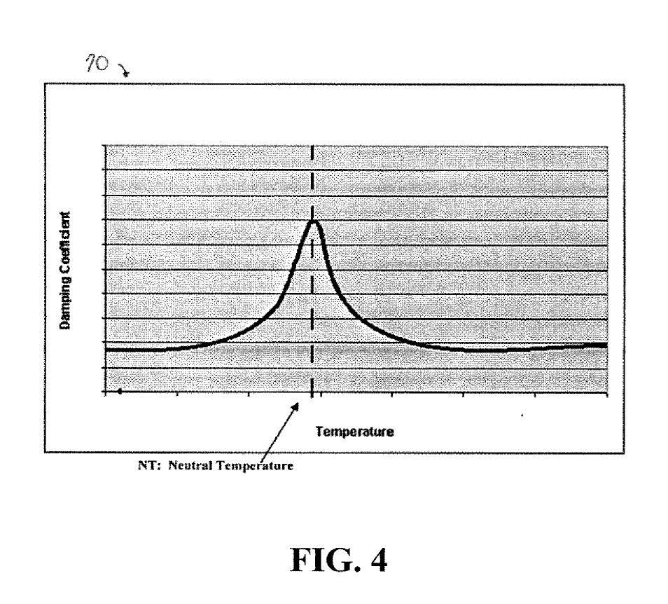

The damping coefficients are calculated for eve induced vibration, as the frequency of the vibration at which the Snoek Effect can be observed in the rail 2 is unknown. Once this frequency of vibration is determined, the damping ratio/coefficient is plotted as a function of temperature. The typical shape of the resultant curve of the damping coefficient for a rail is illustrated in the schematic graph 70 of FIG. 4. Due to the Snoek Effect, a peak in the damping coefficient is observed at a specific temperature NT shown in graph 70. This peak occurs when the metal of the rail 2 undergoes a transition from compressive stress to tensile stress. This temperature in which the peak damping coefficient is the neutral temperature of the metal, i.e. the rail 2 in the present application.

Proper operation of the system 10 and accuracy of the measured neutral temperature can be verified by utilizing the system 10 and method of the present invention on a section of a rail where the neutral temperature is known and can be monitored over an extended time period, for instance 24 hour period, during which the temperature of the rail varies significantly.

Of course, the above described implementation of the system 10 in accordance with the present invention may be modified or reconfigured in other embodiments. For example, other embodiments may include different number of components and sensors that are positioned differently than that described relative to FIG. 2. In this regard, the laser assembly may be mounted facing one side of the rail, and the ultrasonic transducer may be mounted facing the opposite side of the rail in close proximity to the rail, directly across from the laser.

The system and method of determining the neutral temperature of a metal in accordance with the present invention may be applied to determine the neutral temperature in other applications as well. In particular, the system and method of the present invention can be used to determine the neutral temperature of metals where buckling due to thermal stresses is a problem. For instance, another industry dealing with structural failures caused by thermal buckling is the energy industry. Globally, the steel pipeline network is estimated to be around 2 million kilometers. Stresses caused by thermal expansion can cause these pipelines to buckle and even lift out of the ground. This is a major concern for the energy companies, since shutting down a pipeline for repairs can cause major revenue loss. Thus, the system and method of the present invention described above can be used to determine neutral temperature of steel pipelines. Of course, this is merely provided as an example, and the present invention is not limited thereto.

In view of the above, it should be apparent to one of ordinary skill in the art how the system and method of the present invention allows for accurate measurement of the neutral temperature of a metal, such as a steel rail or pipelines. In addition, it should also be apparent that the system and method of the present invention measures the neutral temperature without damaging the metal. Moreover, it should further be evident that the present invention provides such a system and method that is easy to implement and use.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

We claim:

1. A system for determining a neutral temperature of a metal specimen, comprising:
an excitation assembly disposed adjacent to the metal specimen for inducing vibrations to the metal specimen;
at least one vibration detector disposed adjacent to the metal specimen to measure the induced vibrations transmitted in the metal specimen;
a temperature sensor disposed adjacent to the metal specimen to measure temperature of the metal specimen; and
a control/acquisition system for control of the excitation assembly and acquisition of data from the excitation assembly, the at least one vibration detector, and the temperature sensor,
wherein the control/acquisition system calculates damping coefficients for each of the induced vibrations and determines a peak damping coefficient corresponding to the neutral temperature of the metal specimen based upon the acquired data.

2. The system according to claim 1, wherein the excitation assembly includes a laser assembly producing laser pulses to a surface of the metal specimen to generate the induced vibrations.

3. The system according to claim 2, wherein the laser pulses vaporize contaminant particles present on the surface of the metal specimen to generate the induced vibrations.

4. The system according to claim 3, wherein the induced vibrations are produced within the metal specimen over a range of frequencies.

5. The system according to claim 2, wherein the at least one vibration detector includes an ultrasonic acoustical transducer measuring substantially high frequency responses of the induced vibrations transmitted by the metal specimen.

6. The system according to claim 1, wherein the excitation assembly includes a mechanical-based induced vibration system.

7. The system according to claim 6, wherein the mechanical-based induced vibration system includes an impact hammer to generate the induced vibrations.

8. The system according to claim 6, wherein the at least one vibration detector includes an accelerometer measuring substantially low and medium frequency responses of the induced vibrations transmitted by the metal specimen.

9. The system according to claim 1, wherein the metal specimen includes one of a rail and a pipe.

10. The system according to claim 1, wherein the metal specimen includes a body-centered-cubic metal.

11. The system according to claim 1, wherein the temperature sensor includes one of a thermocouple and a non-contacting infrared temperature sensor.

12. A method for determining a neutral temperature of a metal specimen, comprising:
exciting the metal specimen by inducing vibrations to the metal specimen using an excitation assembly;
detecting vibration of the metal specimen caused by the induced vibrations by at least one vibration detector;
sensing temperature of the metal specimen at a location of the induced vibrations by a temperature sensor;
acquiring data from the excitation assembly, the at least one vibration detector, and the temperature sensor; and
calculating a peak damping coefficient corresponding to the neutral temperature of the metal specimen based upon the acquired data.

13. The method according to claim 12, wherein the excitation assembly includes one of a mechanical-based induced vibration system and a laser assembly.

14. The method according to claim 12, wherein the mechanical-based induced vibration system includes an impact hammer to generate the induced vibrations and the laser assembly producing laser pulses to a surface of the metal specimen to generate the induced vibrations.

15. The method according to claim 14, wherein the at least one vibration detector of the mechanical-based induced vibration system includes an accelerometer, and the at least one vibration detector of the laser assembly includes an ultrasonic acoustic transducer.

16. The method according to claim 12, wherein the calculating a peak damping coefficient includes determining a damping ratio for each induced vibration at a sensed temperature of the metal specimen.

17. The method according to claim 16, wherein for substantially medium and substantially high frequency responses, the damping ratio is determined by use of the following equation:
x(t)=Ae^{-ξωt} sin (ω_{d}t+Φ
where ξ is the damping ratio, ω_{d} is the damped natural frequency, A is the amplitude of the signal, and Φ is the phase shift of the signal.

18. The method according to claim 16, wherein for substantially low frequency responses, the damping ratio is determined by use of the 3 db down method.

19. The method according to claim 16, wherein the metal specimen includes one of a rail and a pipe, and the neutral temperature is calculated over a 24 hour period.

20. The method according to claim 16, wherein the metal specimen includes a body-centered-cubic metal.

21. A method for determining maximum damping of one of a rail and a pipe due to thermal stresses, comprising:
inducing vibrations in the one of the rail and the pipe;
detecting the induced vibrations transmitted in the one of the rail and the pipe,
sensing temperature of the one of the rail and the pipe at a location of the induced vibrations; and
acquiring data from the induced and detected vibrations and sensed temperature to calculate a temperature at which net tensile and compressive thermal forces are approximately zero of the one of the rail and the pipe.

22. The method according to claim 21, wherein the induced vibrations are produced by one of a mechanical-based induced vibration system and a laser assembly.

23. The method according to claim 22, wherein the mechanical-based induced vibration system includes an impact hammer for generating the induced vibrations, and the laser assembly includes a laser producing laser pulses to a surface of the metal specimen for generating the induced vibrations.

24. The method according to claim 23, wherein at least one accelerometer is used for the detecting the transmitted vibrations for the mechanical-based induced vibration system, and at least one ultrasonic acoustic transducer to used for the detecting the transmitted vibrations for the laser assembly.

25. The method according to claim 24, wherein the at least one accelerometer detects the transmitted vibrations within one of a substantially low frequency and a substantially medium frequency.

26. The method according to claim 24, wherein the at least one ultrasonic acoustic transducer detects the transmitted vibrations within a substantially high frequency.

27. The method according to claim 21, wherein the temperature is calculated over a 24 hour period to determine the maximum damping.
